(19) United States
(12) Patent Application Publication
(10) Pub. No.: US 2004/0143822 A1
(43) Pub. Date: Jul. 22, 2004

(54) Method and system for compiling a visual representation of a website

(76) Inventors: James de Jager, Jersey City, NJ (US); Rexford L. Wittenburg III, New York, NY (US); Erik Gordon, West Windsor, NJ (US); Michael Reilly, Hoboken, NJ (US)

Correspondence Address: Daniel A. Crowe, Bryan Cave LLP, 211 N. Broadway, Suite 3600, One Metropolitan Square, St. Louis, MO, 63102, US

(21) Appl. No.: 10/345,927

(22) Filed: Jan. 17, 2003

(51) Int. Cl. G06F 9/45

(52) U.S. Cl. 717/140; 717/109

(57) ABSTRACT

A method and system for compiling a visual representation of a web site into machine executable instructions, wherein the visual representation depicts both a visual presentation and logical processing of the web site. One or more logic objects is defined with each logic object having non-visual components that perform information processing tasks. One or more visual objects for visually presenting content and information on the website are then defined. Relationships between the logic and visual objects and then visually defined to create the visual representation of the web site. An execution order is then generated for the one or more logic objects based on the defined relationship between the logic and visual objects. All of the visual objects are translated into fragments of markup language. Machine-executable instructions for execution by a runtime engine are then generated comprising the order in which to execute all logic objects and the fragments of markup language to render.

### FIELD OF THE INVENTION

The present invention relates generally to methods and systems for the development of software and, more particularly, to methods and systems used to create and modify websites.

### BACKGROUND OF THE INVENTION

The use of the Internet and internal intranets for business applications, including for e-commerce activities, is continuing to expand, thus increasing the demands for more sophisticated web sites and web applications. The Internet has transformed the manner in which businesses interact with their customers, suppliers and peers by reducing or eliminating geographic and time-zone barriers. As the range and volume of business applications placed on the Internet increases, the need for powerful, adaptable and easily modified web applications is increasing.

The explosive growth in the use of the Internet and intranets has also increased demand for tools used in the creation and publication of web sites. A web site typically includes a collection of web pages that provide content such as text, graphics, images, and other multimedia materials. The design and development of a web-based application includes attention to two interrelated aspects: the layout or “look-and-feel” of the web site, and the functional components of the web application. Using conventional techniques and programming languages to create a web-based application, the design and layout of a web page is intermixed with its functional characteristics, typically making it difficult to update and/or modify the web site. Because the application logic is intertwined with the graphical user presentation and interface, a redesign of both the underlying logic and the visual aspects of the website is often required if either the functionality and/or the visual presentation of the web site is modified. This problem of integrated graphical presentation and application logic has plagued web application developers for years. Moreover, a typical website or web application development team includes business domain experts, web designers, content developers, database architects, computer programmers, and other related marketing and information technology specialists. It is often difficult to coordinate the efforts of such a large number of contributors who are not highly trained in computer programming techniques. When traditional text-based programming environments are used, the user's programming skills and ability to interact with the computer system often become a limiting factor in the achievement of optimal utilization of the computer system.

Conventional programming techniques use flow charting tools to define flows of execution and the interaction between components in a system. Visual or graphical development environments, such as VISUAL BASIC by Microsoft and PowerBuilder by Sybase are rapidly becoming preferred development tools for quickly creating websites. Graphical development environments often use object oriented programming techniques, which involve the definition, creation and use of software blocks known as objects. These objects typically comprise data elements and functions that operate on the data elements. The data elements and related functions are treated by software programs as encapsulated entities that can be instantiated (created), used and destroyed as a single item. Objects are defined by creating classes, which act as templates that instruct the computer on how to construct the actual object. A class may, for example, specify the number and type of data variables and the steps involved in the methods which manipulate the object's data elements. Graphical development environments allow computer programs to be written with the help of a graphical user interface in which the objects are represented by icons accessible on a display in which the programmer manipulates to create program functionality.

In both conventional flow charting tools and visual development environments, the underlying source code still exists. A flow chart has no direct correlation to the underlying code. Visual representations still only abstract the real underlying source code. Thus, there is a continuing need for a method for designing and developing websites and web applications that reduces the dependence on complex software programming techniques. Preferably, such a method would allow changes to an existing website or web application to be readily made without adverse impact on the application. Such an improved system would include a visual representation that is the underlying source code. Syntax would be simply a matter of how and where lines are drawn, thus allowing the developer to solve problems in a manner intuitive to a person. The system and method would allow for a translation of the visual representation directly into machine-executable instructions.

### SUMMARY OF THE INVENTION

The present invention provides a rapid application development environment that integrates a graphical layout with a visual programming language specifically designed to build web-based applications, allowing the building of interactive, complex, functional web sites without the knowledge of a text-based (traditional) programming language. The separation of visual and logic objects allows developers to concentrate on conceptual and business-rule based development without the limitations of programming language syntax. In addition, separating a website's visual presentation from its underlying programming logic would reduce debugging problems inherent in script-based environments because visual design changes to the website would not interfere with the underlying logic code.

The present invention includes a method for compiling a visual representation of a web site into machine executable instructions, wherein the visual representation depicts both a visual presentation and logical processing of the web site. Initially, one or more logic objects is defined with each logic object having non-visual components that perform information processing tasks. Each logic object has a defined execution flow from a single entry point to at least one exit point. One or more visual objects for visually presenting content and information on the website are then defined. Relationships between the logic and visual objects and then visually defined to create the visual representation of the web site. An execution order is then generated for the one or more logic objects based on the defined relationship between the logic and visual objects. All of the visual objects are translated into fragments of markup language. Machine-executable instructions for execution by a runtime engine are then generated comprising the order in which to execute all logic objects and the fragments of markup language to render.

Another embodiment includes a development system for creating a website that includes means for defining a plurality of visual objects for visually presenting content and information and logic objects comprised of non-visual components that perform information processing tasks of logical and visual objects. This embodiment includes a graphical user interface displaying a representation of the website as a plurality of the visual objects and the logic objects. An editor allowing a user to define relationships between the visual objects and logic objects is also included. This embodiment further includes a compiler for generating an execution order for the one or more logic objects, for translating all visual objects into fragments of markup language, and for generating runtime machine-executable instructions for execution by a runtime engine comprising the order in which to execute all logic objects and the fragments of markup language to render.

### BRIEF DESCRIPTION OF THE DRAWINGS

To facilitate further discussion of the invention, the following drawings are provided in which:

FIG. 1 is a representation of visual programming environment;

FIG. 2 is a flowchart illustrating the steps in the method of compiling a visual representation of a website; and

FIG. 3 is a portion of a visual representation of a website illustrating the interaction between two logic objects.

These drawings are for illustrative purposes only and should not be used to unduly limit the scope of the claims.

### DETAILED DESCRIPTION OF THE INVENTION

The present invention may be used to create a typical page of a website. As is conventionally known, most websites include visual elements that present information and content to the user of the website and logical elements that provide functionality to the site. For example, the visual elements may include the various items displayed on the website, including the images, lines and colors. The logical elements include the elements that generate the data displayed on the website.

The web site may be generated using the method of the present invention by first creating a visual representation of the web site that depicts both the visual presentation and the logical processing of the web site. Initially, one or more logic objects is defined with each logic object having non-visual components that perform information processing tasks. Each logic objects has a defined execution flow from a single entry point to at least one exit point. One or more visual objects for visually presenting content and information on the website are then defined. Relationships between the logic and visual objects and then visually defined to create the visual representation of the web site.

This visual representation may then be compiled into machine executable instructions by generating an execution order for the one or more logic objects based on the defined relationship between the logic and visual objects. All of the visual objects are then translated into fragments of markup language. Machine-executable instructions for execution by a runtime engine are then generated comprising the order in which to execute all logic objects and the fragments of markup language to render. All of these steps are preferably computerized.

A development system, also known as a visual-based programming environment, may be used to create the visual representation of the website. Preferably, the development system includes means for defining a plurality of visual objects for visually presenting content and information and logic objects comprised of non-visual components that perform information processing tasks of logical and visual objects, a graphical user interface displaying a representation of the website as a plurality of the visual objects and the logic objects, and an editor for allowing a user to define relationships between the visual objects and logic objects.

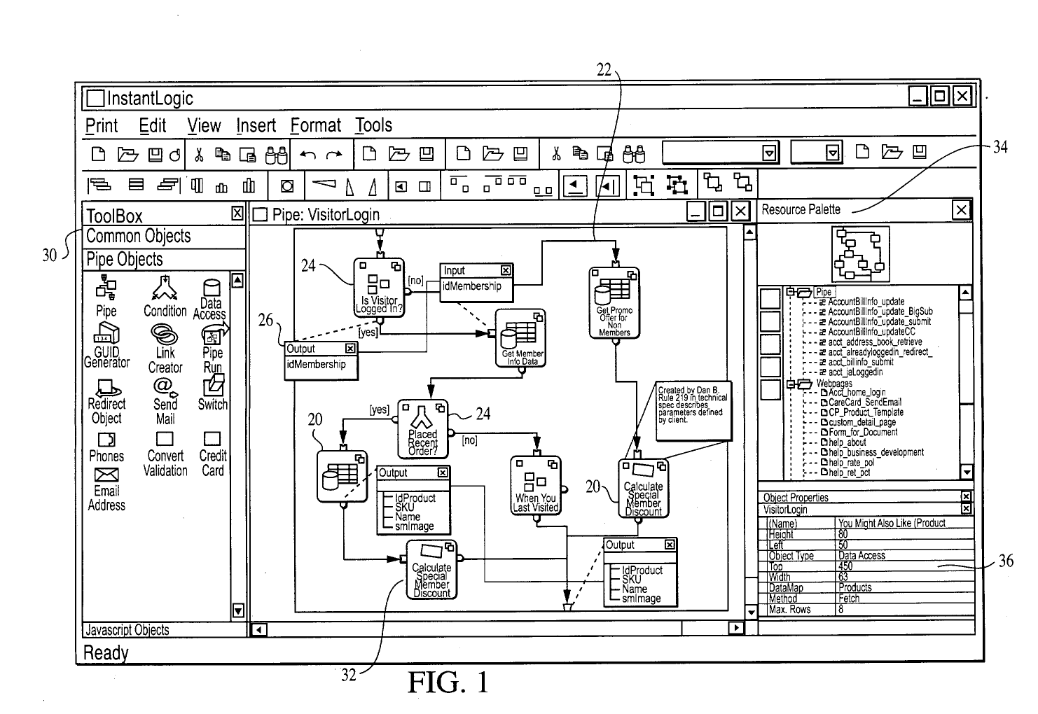

FIG. 1 illustrates one embodiment of a visual-based programming environment for creating and deploying websites and data-driven web applications. The visual based programming environment simplifies the creation of a website or a web-based application by providing a graphical user interface through which a user may design and customize a web application without writing any HTML, scripts, or other programming code.

An object is a small, modular software component that does, or displays, something specific. A logic object contains functionality and is analogous to a subroutine in conventional computer programming techniques having a set of required input variables and produced output variables. A logic object is an encapsulated set of functionality (source code) having a single entry point and one or more possible exit locations. As shown in FIG. 1, each logic object, for example, logic object 24, is represented as an icon that clearly describes its required inputs and produced outputs, and indicates its entry point and possible exit points. These logic objects may be defined by writing small software programs that perform the desired function. By simply drawing lines between various icons, simplistic individual operations can be combined to produce highly complex structures. A pipe object is a type of logic object that is defined as a collection of other logic objects grouped as a single entity. This pipe may then be used as a single object. This allows complex processes to be encapsulated, and represented as a single operation. This single entity can then be used in the same manner as other logic objects, iconically representing a potentially complex set of operations. Pipes, and encapsulation in general, provide two significant benefits. As the process performed by the pipe is constructed in one location, the process need only be modified in one location. By changing the pipe, all places where the pipe is used are updated. Also, as the process is only defined once, the chance for user error from reimplementing the same process multiple times is greatly reduced.

A visual object displays content on web pages, such as text, images, form elements, etc. A visual object may contain several pipes, with no explicit user-generated information as to the order in which to execute them. Visual objects may be defined as small computer programs designed to display some visual element on the web site. Visual objects are used to produce fragments of HTML code. Defined objects, including both logic and visual objects, may be persisted to allow them to be reused by other developers on the development team.

The programming environment enables a website creator to select from among a plurality of features and options to include on the website, including pre-compiled components that enable website developers to assemble complex applications without the need for extensive amounts of hand-written code. The programming environment separates a web site's graphical user interface from its underlying application logic, yet maintains a functional link between these two components. This allows designers and programmers to work separately and contemporaneously on the same projects, so building and maintaining web sites is quicker, easier and less expensive. The programming environment allows developers to position visual objects on a design canvas. These visual elements are later used to create the necessary HTML when the webpage is later compiled.

As illustrated in FIG. 1, the functional components of a web application are represented as icons which may be placed and manipulated on a design canvas 32. The design canvas 32 of FIG. 1 illustrates a representative visual representation for a pipe used to calculate elements to display on a product display screen of a web site. The visual representation includes logic objects 24, such as an object for determining whether the visitor is logged in, and one for determining whether the visitor has placed a recent order. The visual representation also includes data objects 20, such as an object that retrieves a list of products that the visitor may be interested in purchasing, and a scheduled banner advertisement. The visual representation may also include inline references to variables 26, such as the output (here, membership identification) of a logic element designed to determine if the visitor is logged into the web site. The visual representation may also provide creation and version control information regarding the logic and visual objects. Flow control is accomplished by drawing flow lines 22 through the use of an editor between individual components, which assists in defining the relationships between and among the visual and logic objects. Pre-test, post-test and iterative loops can be constructed using flow lines 22 and logic objects 24.

Code reuse is possible, as individual logic objects can be combined together within another special type of object, called a pipe or a visual container. Within a pipe, the order of operations is defined in a flow chart-like fashion and all classical programming constructs such as loops and conditions can be used. Logic objects and even other pipes can be combined with a pipe, and this pipe can then be reused as a single encapsulated entity. A pipe can expose any inputs it requires, and outputs it produces and be used without knowledge of its inner functional workings. These pipes can be used as components of other pipes, or as stand-alone entities.

Similar to logical reuse, reuse of visual objects is possible. Utilizing a property inheritance mechanism, changes may easily be propagated throughout the system between uses of objects. Individual visual elements may be combined to create more complex elements. These may in turn be reused to create even more advanced structures. Instancing an object is the act of using an object as part of a more complex object. The instanced object derives from the original object and has all of its properties. Should the original object be modified, the derived object will reflect these changes, unless the derived object explicitly defined the property itself. Should the derived object be modified, the original object will not be affected. For instance, an object with a color of blue may be used as part of a more complex object. Should the original object's color then be changed to red, the derived object's background will change to red. However, if the derived object's color had been previously changed, the derived object would continue to use its own color, without inheriting the color property from the original object. This relationship is one directional. If the color of a derived object changes, the original object from which it inherits is unmodified. This allows a user to utilize a pre-constructed object, and modify it for the particular situation in which it is used without affecting any other uses of the object. For instance, a company creates a blue object with its logo. This object is then used several places, one of which is on a page with a different color scheme. On the page with the different color scheme, the color of the derived object is set to red. Only the one instance of the object is affected. Should the logo change, the user only needs to modify the original object and the changes will be reflected in all usages of the object. Should the color change, the user modifies the original object, and all usages of the object are changed except the one usage where color was specifically changed. This allows the user the flexibility to create and use reusable objects to simplify maintenance of the site while also allowing the user to modify objects for specific purposes if necessary.

Referring again to FIG. 1, the development environment includes a toolbox 30, where the defined or built-in logic and visual objects may be stored. This toolbox 30 may be updated with custom-built objects or any new objects imported into the environment. The development environment further includes a design canvas 32 onto which visual objects, such as visual object 20, (including pipe objects and entire webpage objects) may be placed and used to create applications and websites. The canvas 32 allows for the design of the graphical look of a web application by defining the relationships between logic and visual elements. The user manipulates the various visual objects which, upon rendering, are converted into a markup language, such as HTML code. A resource palette 34 is included in the development environment to provide developers with an interface to stored web pages and other created objects. The resource palette 34 further allows the developers to check in, check out, and share objects with the entire development team, and provides access to source and versioning control. The development environment also includes an object properties window 36, which becomes active when an object is placed on the design canvas 32. This window 36 allows for the viewing of properties of a selected object. In addition, the developer may alter the properties of an object placed on the design canvas 32 by interacting with the properties window 36. The properties of an object may include height, width, color, etc.

A visual representation of the web site is created based upon predefined logic and visual objects by simply dragging such objects onto the design canvas 32 and inserting flow lines 22 to visually define the relationships between the logic and visual objects. Those skilled in the art of visual programming techniques will readily appreciate this process.

Once the visual representation of the web site is complete, the representation may be compiled into machine executable instructions by means of a compiler that translates all the visual information into an execution plan usable by the run-time engine. In order to compile an individual pipe, the compiler follows execution flow from the entry point of the pipe through all the logic objects (or nested pipes) contained within, to the exit point(s) of the pipe. An execution plan is then constructed to call these logic objects in the correct order. As discussed above, a visual object such as a webpage may contain several pipes, without any explicit user-generated information as to the order in which to execute them. For example, if one pipe produces an output that is required as an input to another pipe, then the pipe generating the output must be executed first. By examining the map lines, the compiler generates a valid execution order for all the pipes contained within the webpage. The execution order is essentially a strategy for determining which elements on the page can be cached as static HTML, which components need to be called to generate dynamic values, and the correct order for accomplishing these tasks.

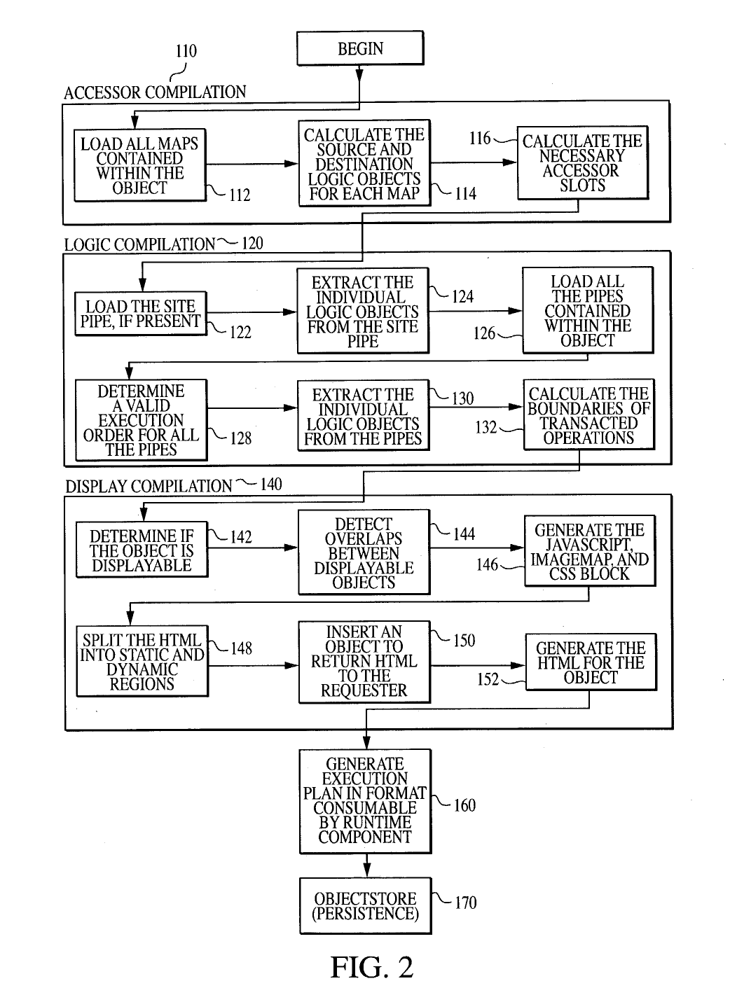

FIG. 2 illustrates the steps in the method of compiling an object to generate an execution plan in a format suitable for use by the runtime engine. The method broadly comprises the steps of accessor compilation 110, logic compilation 120, and display compilation 140. In step 112, the method identifies and loads all maps contained within the object. This step includes both explicit map or flow lines (including lines representing program variables (data) and flow control), and all inline references to variables (e.g., membership identification). The compiler optimizes these maps and generates the instructions for runtime execution, including setup of necessary memory locations. In step 114, the method calculates the source and destination logic objects for each map. This step eliminates the need for extra memory locations or copies for variables that need not exist at runtime. For example, a pipe may potentially have an input node with an input variable. However, in this example, the pipe is purely a logical construct and does not need the variable for execution. Only the components inside the pipe that use the variable need the value. The compiler will then translate the line to directly connect the logic object(s) providing the value with the logic object(s) consuming the value. Thus, although presented as an encapsulated entity to the user in the display environment, the compiler will attempt to create the most efficient use of memory.

One algorithm that may be used to calculate the true source and destination of a map is as follows:

For each variable map line (designated as x),

If the source of the map is the destination for any other map,

Then make the source of x the source of the other map.

This may be iteratively performed on the list of maps until no changes are performed for an entire iteration. In the event that the number of iterations exceeds the number of maps squared, then there is an irresolvable set of maps—for example, if there are only two maps where the source of the first is the destination of the second and the destination of the first is the source of the second. In the event that an irresolvable set of maps exists, the system reports the error to the user and compilation terminates.

The method also automatically determines if a copy of a variable must be made, or if the variable can be directly used. If a variable is only required once, its value may be directly modified. If the same variable is required multiple times, a copy is performed for all but one of the uses. In this manner, a logic object cannot inadvertently overwrite the input of another logic object and preserves the semantics of the visual layout in the execution plan.

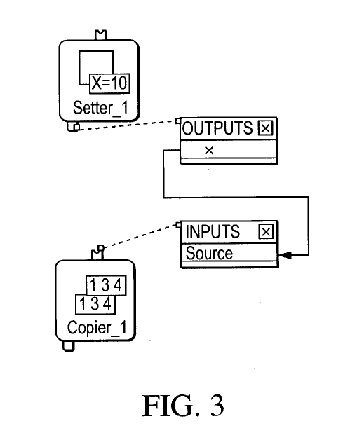

In step 116, the method calculates the necessary accessor slots, which are used to set up the memory structure at runtime. During execution, logic objects accept and return their parameters using a structure called the accessor, which essentially functions as a table having keys and values that may be retrieved or set for those keys. An arbitrary key value is created for each required location in the table, and each individual logic object is told how its variables map to those arbitrary key values. For example, for the portion of a visual representation of a web site depicted in FIG. 3, the table initially is:

| Name | Value |
|---|---|
| 0 | [empty] |

The first logic object, “Setter_{—}1”, produces a single output “x”. The second logic object, “Copier_{—}1”, accepts a single input, “Source”. Because “x” is mapped to “Source”, they must share the same location in the table. “Setter_{—}1” must place its output value in the same location in the table that “Copier_{—}1” reads from. The compiler determines the need for the accessor slot, and determines how the logic object's variables map to the slots. “Setter_{—}1” is told “x” is in slot “0”. “Copier_{—}1” is told “Source” is in slot “0”. As an example, assume that “Setter_{—}1” produces the value “2003”. After execution of “Setter_{—}1”, the table is:

| Name | Value |
|---|---|
| 0 | 2003 |

Now, when “Copier_{—}1” executed, it attempts to retrieve the value for its “Source” variable from slot “0,” which now contains the value “2003.” This is the manner in which values are passed between logic objects during execution. The compiler makes the determination that a single slot (“0” above) was required, and that “x” from “Setter_{—}1” and “Source” from “Copier_{—}1” both used this slot.

The method then continues with step 122 in which the compiler will load the site pipe if one is present. In the event that common functionality for all pages within a site is required, the user has the ability to construct a single pipe to be included in all pages, thus reducing the need for time-consuming and error-prone repetitive work. This pipe, referred to as the site pipe, is compiled in the same manner as any other execution plan, and is then incorporated into every other execution plan generated by the compiler for that site. Examples of such common functionality include a click tracker or a user information lookup table. A site pipe may be defined as a logic object containing actions that are performed for each page within a website. These site pipes may included nested pipes. All sites may potentially have a unique site pipe construct associated with the site and then all pages within the site will run that pipe before running its own objects. As an example, a site pipe may be a counter that tracks the number of users to each page of the website. Next, in step 124, the compiler will extract the individual logic objects from the site pipe. The extracted objects are placed in a memory space.

In step 126, all of the pipes contained within the object being compiled are loaded into the memory space. The compiler will then determine the execution order for the executable objects (step 128). The execution order or plan is initially determined by iteratively examining each object, determining the object's requirements, and determining if the object's requirements have been satisfied by examining the objects previously placed in the execution plan. If the object's requirements have been met, the object is inserted into the execution plan; if not, the object is skipped on that particular iteration. This methodology is repeated until all objects have been inserted into a valid execution plan. By keeping track of the number of iterations of the algorithm, one can determine if a valid execution plan exists for the executable objects. For example, if the algorithm is performed more times that the number of objects squared, then no valid execution order exists.

After a valid execution order is determined, the pipes must be broken down into their component parts. In step 130, each individual logic object is extracted from the pipes. A pipe is purely a logical construct to encapsulate functionality—it has no functionality itself. The logic objects contained within a pipe (and the logic objects contained within contained pipes) must be inserted into the execution plan. This is accomplished by following the execution flow lines from the input node of the pipe to the output nodes of the pipe. Order of execution within a pipe is explicitly defined, as opposed to non-related logic objects and pipes appearing on a visual object. As pipes can potentially contain other pipes, this must be performed recursively. At this point, a valid execution order for the individual logic objects on a page has been determined. Pipes (logic objects which are in turn constructed of other logic objects) have been deconstructed into individual executable components. The logic objects are now in a form from which a valid execution plan can be generated.

In step 132, transaction maintenance objects are inserted by calculating the boundaries of the transacted operations. A pipe is referred to as transacted if all individual components must complete successfully—otherwise none of the individual components can occur. For example, a particular e-commerce web application may be designed to send an order to a fulfillment warehouse only after the purchaser's credit card is successfully authorized. Thus, in the event that the purchaser's credit card is declined, the logic object to abort the purchase is executed. The compiler first inserts a logic object to begin the transaction. At the “commit” exit points of a transacted pipe, the compiler will insert a logic object to perform the committal of the transaction. At the “abort” exit points of a transacted pipe, the compiler will insert a logic object to perform the abort process of the transaction. As there may potentially be multiple discrete transacted pipes, a single execution plan may have multiple commit and abort objects. Each individual object participating in a transaction is also marked with an identification for that transaction, which allows logic objects to know in which transaction they are participating should multiple transactions exist.

At this point, the method has generated a list of logic objects and an execution order that defines the order that those logic objects will execute. Next, the method performs display compilation in step 140 by compiling all visual elements into fragments of markup language, for example, platform and browser neutral HTML. If the object being compiled is a visual object, the compiler must generate the necessary HTML to draw the object. First, the method determines if the object is a displayable object (step 142). In step 144, the compiler will detect any overlaps between visual objects, as distinct HTML elements cannot overlap in most browsers. In step 146, the compiler will generate the JavaScript by searching an object and all contained objects for JavaScript scripts to be executed. It then constructs a script block for the header of the HTML page generated, imagemap and CSS block. The compiler will look for images with associated imagemap data, and construct an HTML imagemap. In order to preserve the positioning of all contained objects, the compiler constructs an HTML table which, after rendering, is preferably reduced in size by spanning empty rows and columns where possible.

In step 148, the rendered HTML code is split into static and dynamic regions. As the outputs of logic objects may be displayed on a page, and certain visual objects cannot be rendered until execution time, a purely static string of HTML code cannot be generated at compile time. The compiler therefore generates all HTML possible, and splits it into static regions. Between these static regions of HTML, is where the dynamically generated HTML is placed at runtime. The compiler inserts another logic object into the execution plan specifically designed to interlace the static and dynamic HTML code at execution (step 150). The output of this logic object is the completed HTML that is sent back to the requesting browser (step 152).

In the event that the compiler detects any errors, the compilation may terminate and such errors may be reported to the user. The display compilation 140 step is repetitively performed for each display object on the webpage.

In step 160, the execution plan is generated in a format consumable by the runtime component, such as an ILX file. This ILX file contains all information about the initial memory locations and values (generated as part of the accessor compilation 110), the inputs and outputs of logic objects and their corresponding memory locations, the order in which to execute logic objects, and the HTML to return to the browser. In step 170, the execution plan for the object may be stored in memory for providing source control and versioning.

The present invention allows for almost infinite extensibility of the design environment and the visual programming language that is used to created the Web applications, by allowing developers to add new logic and visual objects to the design environment to customize the application to their particular needs. Newly created objects automatically become a part of the visual environment and retain all the benefits that visual programming and the compiler provide to the developer.

The logical and visual functionality is extensible because the runtime and design environments support plugable components implemented using predefined entry points into pieces of executable code. The extending code must have at least two interfaces—one to allow the object to interact with the design environment and one to allow the object to interact with the runtime engine. The interface with the design environment supplies various pieces of information, such as variables expected, possible exit points, and the variables returned at each exit point. The interface to the runtime engine allows the object to interact with the runtime component, where the actual task of the object is performed. For example, consider a logic object that generates a random number. The interface to interact with the user environment would supply the information that the object expected a single input, a seed to use for the random number generation. The interface would also indicate it had two possible exit points, one indicating the random number was successfully generated and the other indicating a failure occurred. Finally this interface would indicate that it had two output variables. One, an error message, would be associated with the failure exit point while the other, the random number, would be associated with the success exit point.

The interface to interact with the runtime environment is where the generation would actually be performed. As discussed above, the runtime interface accepts a structure, called an accessor, that contains its inputs and to which it writes it outputs. The runtime component reads its input value, the seed, from the accessor and attempts to generate the random number. If it successfully generates the number it writes the number to the accessor and returns an exit code indicating success causing the runtime to follow the path of execution from the success exit point as laid out in the design environment. If the object is unable to generate the number it instead writes the error message to the accessor and returns an exit code indicating failure. The runtime then instead follows the path of execution from the failure exit point.

It should be appreciated that the present invention (including extensibility through custom visual and logic objects) may be implemented using any programming language that supports polymorphism and is not limited to those generating Microsoft COM objects.

By combining traditional aspects of web application development with a completely visual interface, the present invention greatly reduces both the knowledge and time required to build a web application. Although the present invention has been described in considerable detail with reference to certain preferred versions thereof, other versions are possible without departing from the spirit and scope of the present invention. Therefore the scope of the appended claims should not be limited to the description of the preferred embodiments described herein.

What is claimed is:

1. A method for compiling a visual representation of a web site into machine executable instructions, wherein the visual representation depicts both a visual presentation and logical processing of the web site, the method comprising:
(a) defining one or more logic objects, each logic object comprised of non-visual components that perform information processing tasks, the logic objects having a defined execution flow from a single entry point to at least one exit point;
(b) defining one or more visual objects for visually presenting content and information on the website;
(c) visually defining relationships between the logic and visual objects to create the visual representation of the web site;
(d) generating an execution order for the one or more logic objects from the visual representation of the web site and based on the defined relationship between the logic and visual objects;
(e) translating all visual objects into fragments of markup language; and
(f) generating an execution plan of runtime machine-executable instructions for execution by a runtime engine comprising the logic objects in their execution order and the fragments of markup language to render.

2. The method of claim 1 wherein the step of generating the execution order comprises the step of traversing the execution flow from the entry point of each logic object to each of its exit points.

3. The method of claim 1 wherein the logic objects have one or more input variables and the step of generating the execution order comprises the steps of:
(a) sequentially reviewing each logic object to determine if its input variables have been established;
(b) if so, then inserting the logic object into the execution order; and
(c) repeating steps (a) and (b) until all logic objects are placed into the execution order.

4. The method of claim 1 wherein the step of defining the logic objects comprises the step of classifying one or more of the logic objects as a non-requestable logic objects that can only be compiled when used as components of requestable objects.

5. The method of claim 1 where the step of translating all visual objects into fragments of markup language comprises the step of generating a statically-compiled code portion of HTML and a dynamically-compiled code portion of HTML, wherein the statically-compiled code portion of HTML is generated during the translation step and the dynamically-compiled code portion of HTML is generated during a subsequent runtime step of executing the machine-executable instructions.

6. The method of claim 5 further comprising the step of compiling the dynamically-compiled code portion of HTML when the dynamically-compiled code portion is requested to be executed at run-time.

7. The method of claim 5 wherein the step of translating further comprises the step of inserting a logic object having an output comprising HTML code into the execution plan to interlace the static and dynamic HTML regions during the runtime step.

8. The method of claim 1 further comprising the step of optimizing the execution plan, the optimizing step comprising the steps of:
(a) successively reviewing each logic object in the execution plan to determine if the logic object is dependent on the preceding logic object in the execution plan in order to execute;
(b) if not, exchanging the logic object and the preceding logic object in the execution plan; and
(c) repeating steps (a) and (b) for each logic object in the execution plan until the execution plan has been reviewed with no exchanges made.

9. The method of claim 1 wherein the step of defining one or more visual objects comprises the steps of:
(a) defining an original visual object having a set of properties; and
(b) instancing one or more visual objects, wherein the one or more visual objects inherit the set of properties from the original visual object.

10. The method of claim 9 further comprising the step of modifying the set of properties of the original visual object wherein the modified properties are then applied to each instanced visual object.

11. The method of claim 9 further comprising the steps of modifying a particular property within the set of properties of an instanced visual object, then modifying the set of properties of the original visual object, wherein the step of modifying the set of properties of the original visual object has no effect on the modified particular property of the instanced visual object.

12. The method of claim 1 wherein one or more of the visual and/or logic objects is defined as a separate component having a predefined entry point into machine-executable instructions, wherein such machine-executable instructions are inserted into the execution plan.

13. A computer-readable medium having computer-executable instructions for performing the steps recited in claim 1.

14. A compiler for compiling a visual representation of a web site into machine executable instructions, the visual representation defining relationships between a plurality of visual objects for visually presenting content and information and logic objects comprised of non-visual components that perform information processing tasks, the compiler comprising:
(a) means for generating an execution order for the one or more logic objects based on the defined relationship between the logic and visual objects;
(b) means for translating all visual objects into fragments of markup language; and
(c) means for generating runtime machine-executable instructions for execution by a runtime engine comprising the order in which to execute all logic objects and the fragments of markup language to render.

15. A development system for creating a website comprising:
(a) means for defining a plurality of visual objects for visually presenting content and information and logic objects comprised of non-visual components that perform information processing tasks of logical and visual objects;
(b) a graphical user interface displaying a representation of the website as a plurality of the visual objects and the logic objects;
(c) an editor for allowing a user to define relationships between the visual objects and logic objects;
(d) a compiler for:
generating an execution order for the one or more logic objects based on the defined relationships between the visual and logic objects;
translating all visual objects into fragments of markup language; and
generating runtime machine-executable instructions for execution by a runtime engine comprising the order in which to execute all logic objects and the fragments of markup language to render.
